(19) United States
(12) Patent Application Publication
(10) Pub. No.: US 2007/0172280 A1
(43) Pub. Date: Jul. 26, 2007

(54) Methods and apparatus for printing of personalized publications

(75) Inventor: Michael H. Dwyer, Nixa, MO (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: That's Me Publishing, LLC

(21) Appl. No.: 11/518,810

(22) Filed: Sep. 11, 2006

Related U.S. Application Data
(60) Provisional application No. 60/759,321, filed on Jan. 17, 2006.

(51) Int. Cl. B41J 5/30

(52) U.S. Cl. 400/62

(57) ABSTRACT

A method for preparing and printing a personalized book utilizing a software package installed on a personal computer is provided, wherein the method includes entering, via one or more graphical user interfaces displayed on the computer, personalization features for at least one character in the book, and editing, via one or more additional graphical user interfaces displayed on the computer, at least one of character names and text of a story included in the software package. The method also includes running a printer test to determine an orientation for blank pages on which the personalized book will be printed with respect to a printer connected to the personal computer, and printing the pages of the book in a single pass of the blank pages through the printer. The single printing pass includes the printing of the personalized text, personalized characters, and background illustrations. The method also includes binding the printed pages of the book.

### CROSS-REFERENCE TO RELATED APPLICATIONS

This application claims the benefit of U.S. provisional application No. 60/759,321 filed Jan. 17, 2006, which is herein incorporated by reference in its entirety.

### BACKGROUND OF THE INVENTION

This invention relates generally to printing of publications, and more specifically, to methods and apparatus for printing of personalized publications, for example, personalized children's books.

Generally, the prior art includes many examples of personalized children's books. In one specific example, an offset printing process is utilized to provide personalized text and graphics which are producible in a continuous process. When the purchaser wishes to order a book, he fills out and mails to the publisher a short questionnaire. In accordance with the supplied data, the text is then personalized and individual physical characteristics of the selected child are superimposed onto a pre-printed, fairly generic, background of illustrations. In this example, the personalization includes additive line detail, color, and shading that are developed corresponding to basic preprinted, multi-colored background illustrations. A laser printer overprints the personalization over the preprinted background pages. This example is applicable to a situation where the so called personalized books are mass produced. Each book produced under such a system may include personalization features such as a name in text, and certain other features in the overprinted graphics (i.e., skin tone and hair color). Since the pages are run through printers in two separate processes (i.e., first, background text and illustrations and then personalization), expense is added to the product. This book must be ordered, and cannot be sold “off the rack”. As a result, a purchaser has to wait a number of days or weeks before his book is received. Furthermore the amount of personalization within such a book is limited.

In another specific example, a completely pre-bound blank board book is utilized with personalized stickers that are printed and affixed to each page, including the cover, of the board book. The book is printed and bound by the publisher using standard publishing methods, except that blank areas are left in specific locations on the inside pages. The purchaser buys the partially blank book. He fills out a personalization questionnaire included with the book and sends the data to the publisher. The publisher prints personalized stickers and mails them to the purchaser. The purchaser inserts the stickers into the appropriate blank spaces in the book. The customer can give the book as a gift without having to know the personalization data for the recipient, since the recipient can send for the stickers himself. While providing a personalized cover, this example has other drawbacks. A first drawback for the publisher is the expense of printing individual stickers for every purchaser. A further problem is that the customer or recipient must wait for the personalized stickers to be mailed back from the publisher before the book can be completed, or wait while the stickers are printed at the point of sale. The text in these books is personalized to a small degree, but the illustrations are not personalized. These unfinished books can be sold off the rack and taken home by the customer, but the customer still needs the seller to complete the book for him. In addition, sticker books are not generally as desirable as books printed directly onto paper.

In still another example, a software program containing a generic story is loaded into a computer at the point of sale. Personalized data from a customer is entered into the program and merged into the story. The personalized story text is printed onto blank areas on sheets of paper that have preprinted illustrations covering one side and partially covering the other side. The finished sheets are assembled and bound with the cover. This process is designed to be rapid enough to take place while the customer waits, but the wait can be of considerable length. Many customers do not have the time. Another problem is that the customer may not have the all of the appropriate personalization data readily available at the time of sale, for example, the names of a child's friends. In this example, some personalization of the text is provided, but no personalization of the illustrations or of the cover. Furthermore, the requirement for a computer operator to gather the personalization data at the point of sale and the subsequent printing of the text on the sheets that have been preprinted with the illustrations means that the book is relatively expensive to produce and cannot be sold off the rack to the customer without further handling at the point of sale.

In order for a personalized book to be mass marketed, the book kit should be sold without requiring any additional supplies or services from the publisher or reseller. The book should offer extensive personalization, but the personalization, printing and binding operations should be as simple as possible for the customer. In addition, for a professional appearance, the personalized book should be printed with a single printing process, and without incorporating labels (e.g., stickers) to provide personalization features.

### BRIEF DESCRIPTION OF THE INVENTION

In one aspect, a method for preparing and printing a personalized book utilizing a software package installed on a personal computer is provided, wherein the method includes entering, via one or more graphical user interfaces displayed on the computer, personalization features for at least one character in the book, and editing, via one or more additional graphical user interfaces displayed on the computer, at least one of character names and text of a story included in the software package. The method also includes running a printer test to determine an orientation for blank pages on which the personalized book will be printed with respect to a printer connected to the personal computer, and printing the pages of the book in a single pass of the blank pages through the printer. The single printing pass includes the printing of the personalized text, personalized characters, and background illustrations. The method also includes binding the printed pages of the book.

In another aspect, a computer-readable medium for use in a personal computer is provided, wherein the computer readable medium has recorded thereon machine readable instructions configured to cause the personal computer to display one or more graphical user interfaces that allow a user to personalize features for at least one character in a book, and display one or more additional graphical user interfaces that allow a user to edit at least one of character names and a text of a story included on the computer readable medium. The computer readable medium also includes machine readable instructions configured to instruct a printer connected to the personal computer to run a printer test to determine an orientation for blank pages on which the personalized book will be printed with respect to the printer, and instruct the printer to print the pages of the book in a single pass of the blank pages through the printer. The single printing pass includes the printing of the personalized text, the personalized characters, and background illustrations.

In a further aspect, a kit for personalizing a book is provided, wherein the kit includes software configured to be installed on a personal computer and configured to allow a user to personalize the book by editing at least one of character names and a text of a story included in the software, personalize characteristics for one or more characters in the book, and print pages of the book. The kit also includes a front cover, a back cover; and a plurality of blank pages configured to have the personalized text, the personalized characters, and background illustrations printed thereon in a single pass of the blank pages through a printer. The kit also includes a printer test page configured to allow a user to properly align the blank pages in a printer connected to the personal computer, and a binding material configured to bind the plurality of pages between the front cover and the back cover.

### BRIEF DESCRIPTION OF THE DRAWINGS

FIG. 1 is a block diagram of a system configured to produce personalized books.

FIG. 2 is a diagram illustrating components of a kit that allows a purchaser to personalize and print the pages for a book utilizing his home computer.

FIG. 3 is a flowchart illustrating a method for the production of personalized books.

FIG. 4 is flowchart illustrating a book personalization and printing process.

FIG. 5 is an example welcome screen.

FIG. 6 is an example license screen.

FIG. 7 is an example name entry screen.

FIG. 8 is an example gender entry screen.

FIG. 9 is an example hair style entry screen.

FIG. 10 is an example hair color entry screen.

FIG. 11 is an example skin tone entry screen.

FIG. 12 is an example eye color entry screen.

FIG. 13 is an example shirt color entry screen.

FIG. 14 is an example pants color entry screen.

FIG. 15 is an example confirm colors screen.

FIG. 16 is an example adults in story entry screen.

FIG. 17 is an example friends in story entry screen.

FIG. 18 is an example previewing book pages screen.

FIG. 19 is an example edit book pages screen.

FIG. 20 is an example of a book page that does not include any editable text.

FIG. 21 is an example print configuration test screen.

FIG. 22 is an example determine printer mode screen.

FIG. 23 is an example ready to print book pages screen.

FIG. 24 is an example help screen.

FIG. 25 is an example book finished screen.

FIG. 26 is an illustration of a cover for a personalized book.

### DETAILED DESCRIPTION OF THE INVENTION

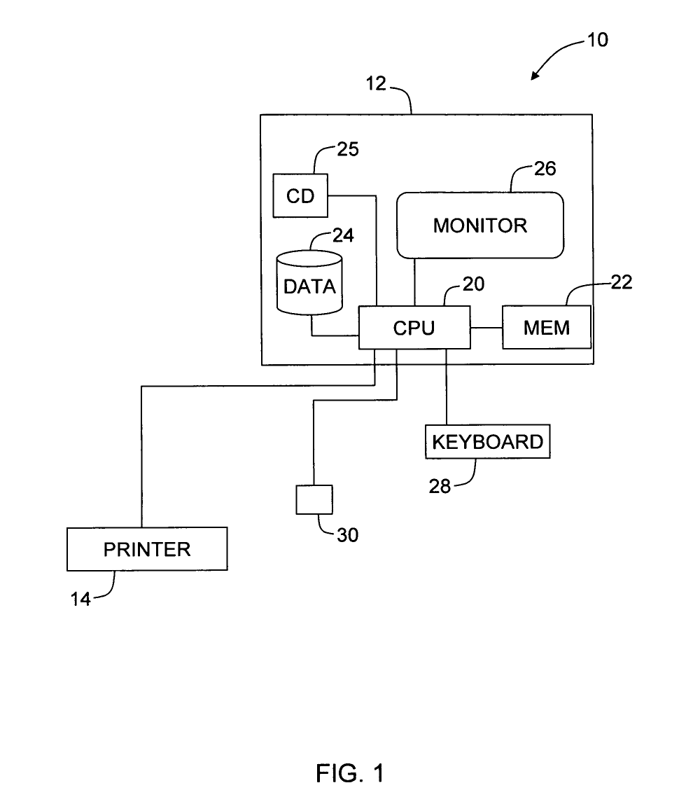

FIG. 1 is a block diagram of one embodiment of a system 10 configured to provide personalized books. System 10 includes a standard personal computer 12 and a printer 14. In particular embodiments, printer 14 is a standard page printer. Computer 12 includes a central processing unit (CPU) 20, which is communicatively connected to a memory 22, a storage unit or disk drive 24, a CD-ROM drive 25, a monitor 26, a keyboard 28 and a mouse 30. Installed and stored on, for example, a CD-ROM and accessible utilizing CD-ROM drive 25 is a software program which configures system 10 and allows users to rapidly personalize and print, for example, a personalized children's book. Personalization data is entered into system 10, utilizing one or more of keyboard 28 and mouse 30.

After entry of the personalization information, as further described below, the user is able to review the book, including the personalization contents, using monitor 26, and make changes or edits if desired. After review and entry of any edits, using paper provided with the CD-ROM, the user is able to print the pages of the personalized book using printer 14.

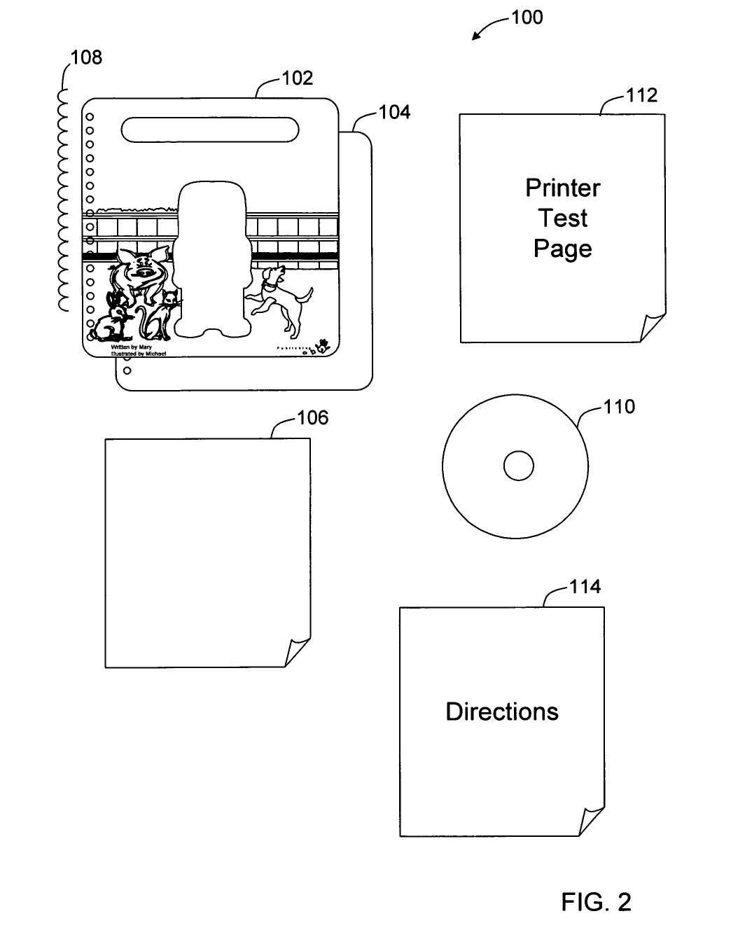

FIG. 2 is a diagram illustrating one exemplary embodiment of a kit 100 that allows a purchaser to personalize and print the pages for a book utilizing his home computer, for example, system 10 (shown in FIG. 1). Kit 100 includes a front cover 102, a back cover 104, and a plurality of pages 106 that, after personalization, are inserted between front cover 102 and back cover 104 and bound utilizing a length of supplied binding material, for example, coiled (or spiral) binding 108. A CD-ROM 110 is included in kit 100 which provides a software program that walks the user through the steps required to personalize and print. Further, a printer test page 112 and directions 114 for binding the personalized book product are also included in kit 100.

As everything needed to personalize and print the book is supplied (assuming the user has access to a computer and printer), purchasers of kit 100 do not have to wait at a point of sale for a seller to enter personalization data and print the book. In addition, as the user is using the software program himself, and the text and illustrations are not preprinted, additional personalization might be added to the book that may not be available in a mail order or point of sale personalization setting.

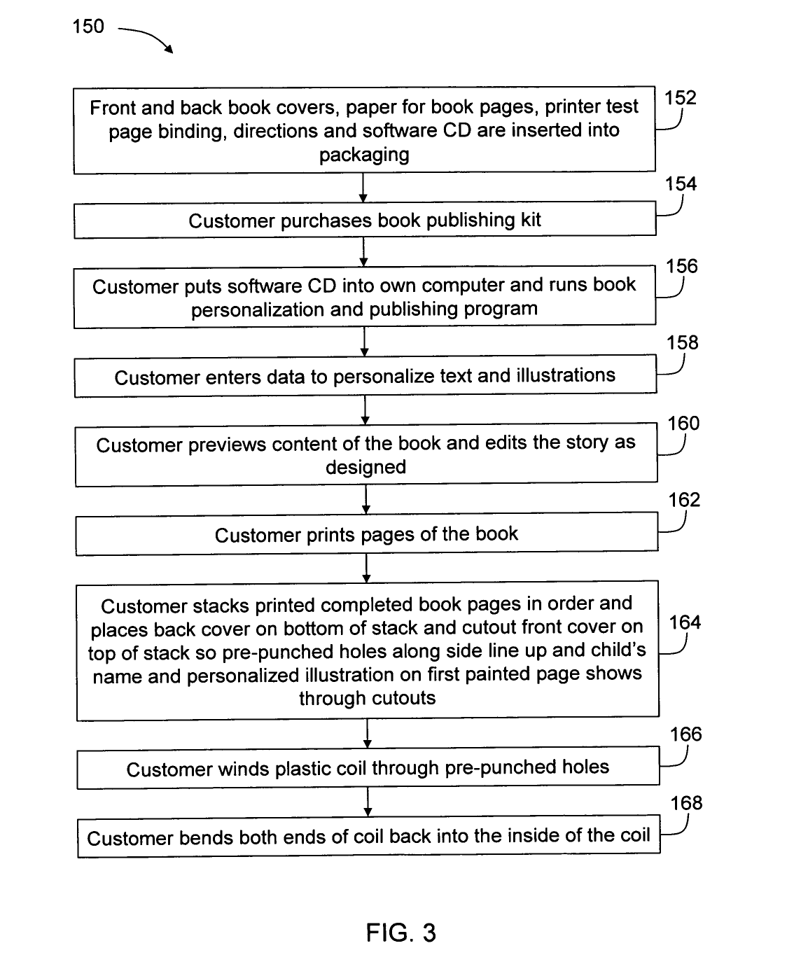

FIG. 3 is a flowchart 150 that illustrates the method for production of personalized books from the packaging of kit 100 (shown in FIG. 2) by a manufacturer and seller of kit 100 to the binding of the finished product by the consumer user. Specifically referring to FIG. 3, a front cover, back cover, pages (e.g., paper), binding coil, printer test page, directions, and CD-ROM with personalization software program are inserted 152 into packaging and set up for sale. The user purchases 154 kit 100 and runs 156 the software program on a computer.

In the course of running the software program the user enters 158 personalized text and personalized illustration data as further described below. Examples of such personalized text and illustration data include a child's name, gender, hair style, hair color, skin tone, eye color, shirt color, pants color, and the names of adults and friends in the story. Such personalized features are sometimes referred to in somewhat generic story text that is stored within the computer (taken from the CD-ROM) and are typically interleaved into the generic story text, when the personalized book is stored and printed.

After entry and selection of the personalization data into the computer, the user reviews 160 the content of the personalized book and edits the story as desired. Print media, for example, the paper (pages 106) is fed 162 to a printer where the generic story text, generic graphical features, and personalized features, both textual and graphic, are printed in a single pass through the printer. After the pages 106 are printed, the user stacks 164 the printed pages and places the back cover 104 on the bottom of the stack and the front cover on top of the stack so that pre-punched holes align and the child's name and personalized illustration show through cutouts on the front cover. The user winds 166 the coil through the pre-punched holes and bends 168 ends of the coil back into an inside of the coil.

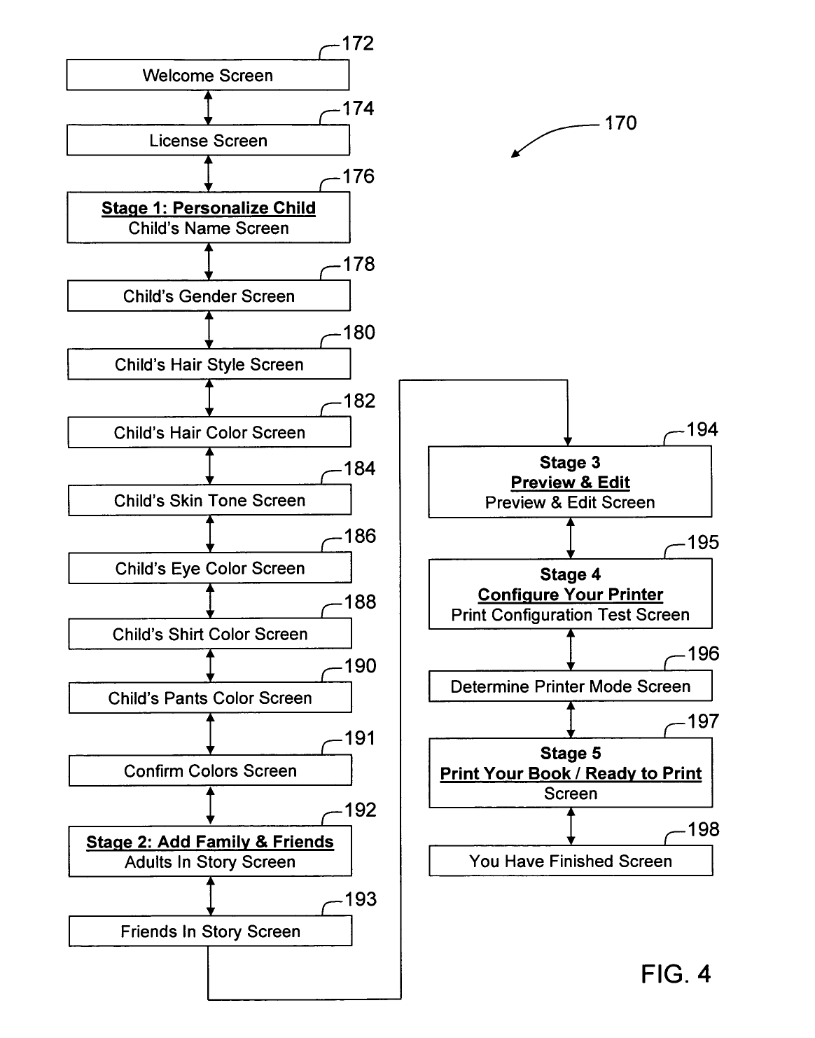

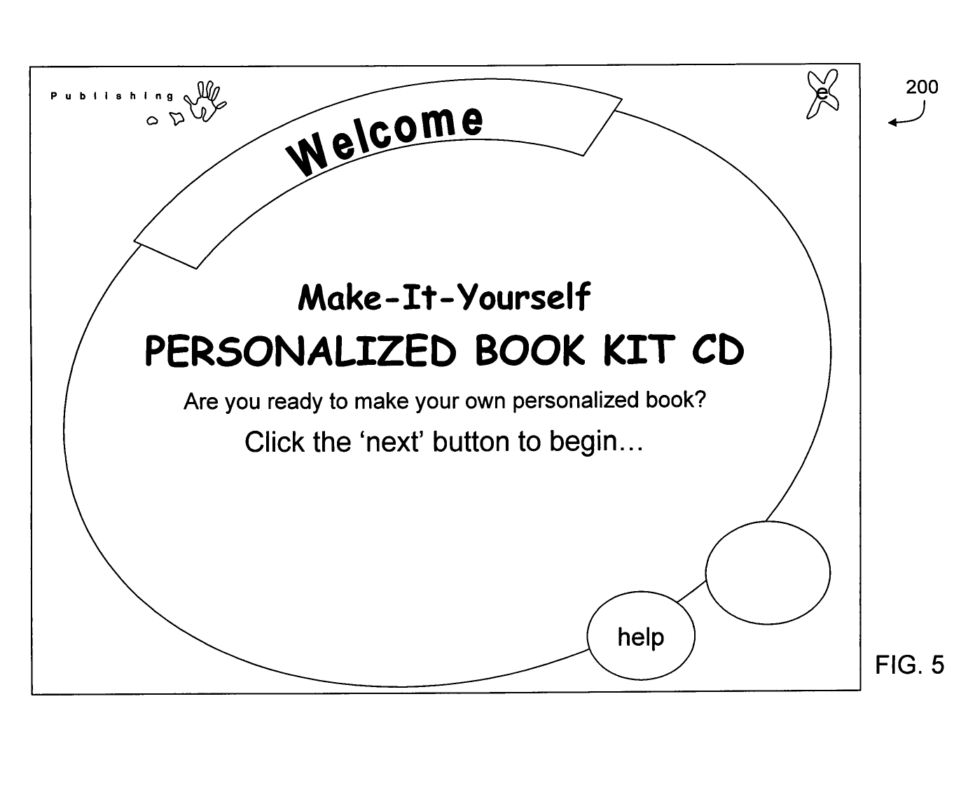

FIG. 4 is a flowchart illustrating a book personalization process 170 that is further illustrated by FIGS. 5-25, which are example screens that may be presented to a user of kit 100 when personalizing and reviewing entered personalization data. Referring specifically to FIG. 4, process 170 includes displaying 172 a welcome screen and displaying a license screen 174. To personalize a child, a user: enters 176 a child's name, enters 178 a child's gender, enters 180 a child's hair style, enters 182 a child's hair color, enters 184 a child's skin tone, enters 186 a child's eye color, enters 188 a child's shirt color, enters 190 a child's pants color, and upon entry of these personalization traits, a confirm colors screen is displayed 191. To add family and friends to the personalized book and story, a user: enters 192 the names of adults appearing in the story and enters 193 the names of friends appearing in the story.

After entry of the above described personalization details, preview and edit screens are displayed 194. A print configuration test screen is then displayed 195 as well as a screen which allows a user to determine 196 a mode of his printer. Once the printer has been tested and its mode of operation determined 196, a ready to print screen 197 is displayed. Once all of the pages have been printed, a finished screen is displayed 198. As described above, a detailed description for each of the above listed screens is provided below.

FIG. 5 is a welcome screen 200 that asks the user if he is ready to make his personalized book. The user may select a next button to proceed to the next data entry screen.

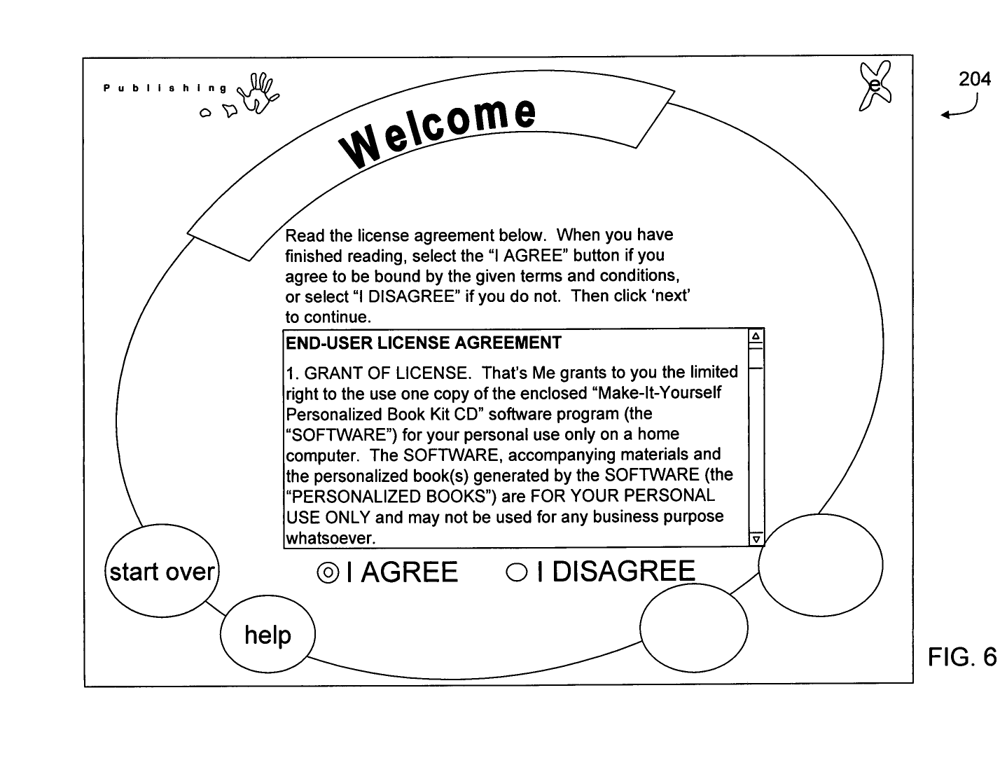

FIG. 6 is an example of an end-user license agreement screen 204. The user has to select that he agrees to the terms in the license agreement, shown as being within a text box 206 in order to proceed with preparation of the personalized book. After selecting that he agrees with the terms of the license agreement, the user may select a next button to proceed to the next data entry screen or a back button to go back to the welcome screen 200. Selection of a “start over” button also causes the welcome screen 200 screen to be displayed, with loss of all previously entered data, as is the case with all of the screens described below.

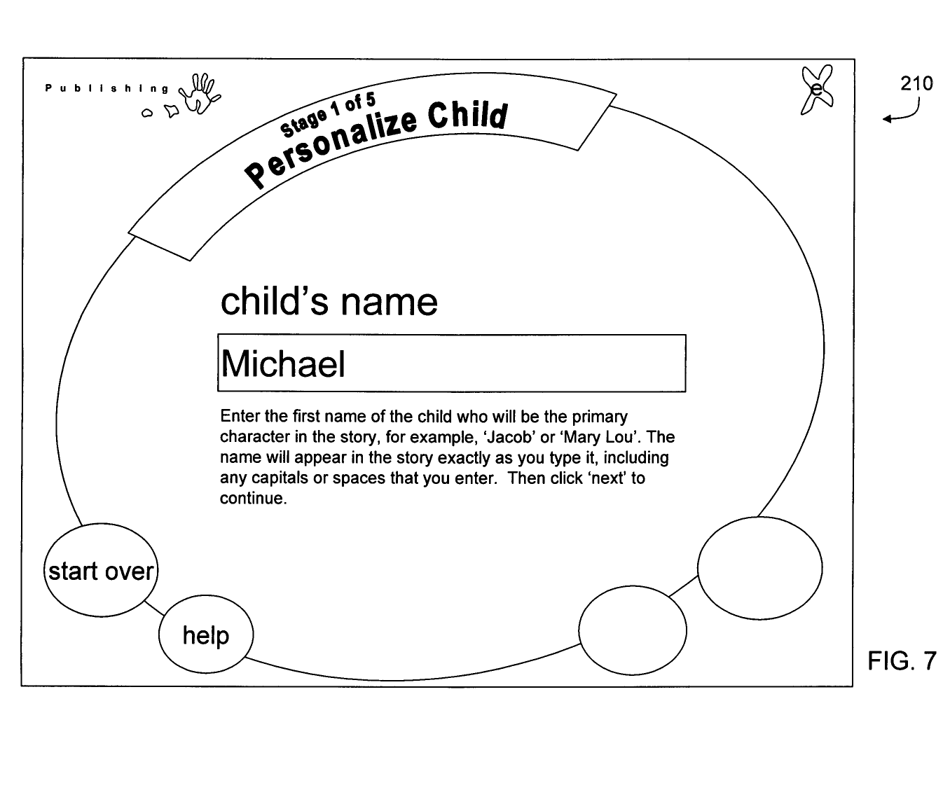

FIG. 7 is a name entry screen 210 through which a user of kit 100 may enter the name of the child for whom the personalized book is being prepared. After name entry, the user may select a next button to proceed to the next data entry screen or a back button to go back to the license agreement screen 204.

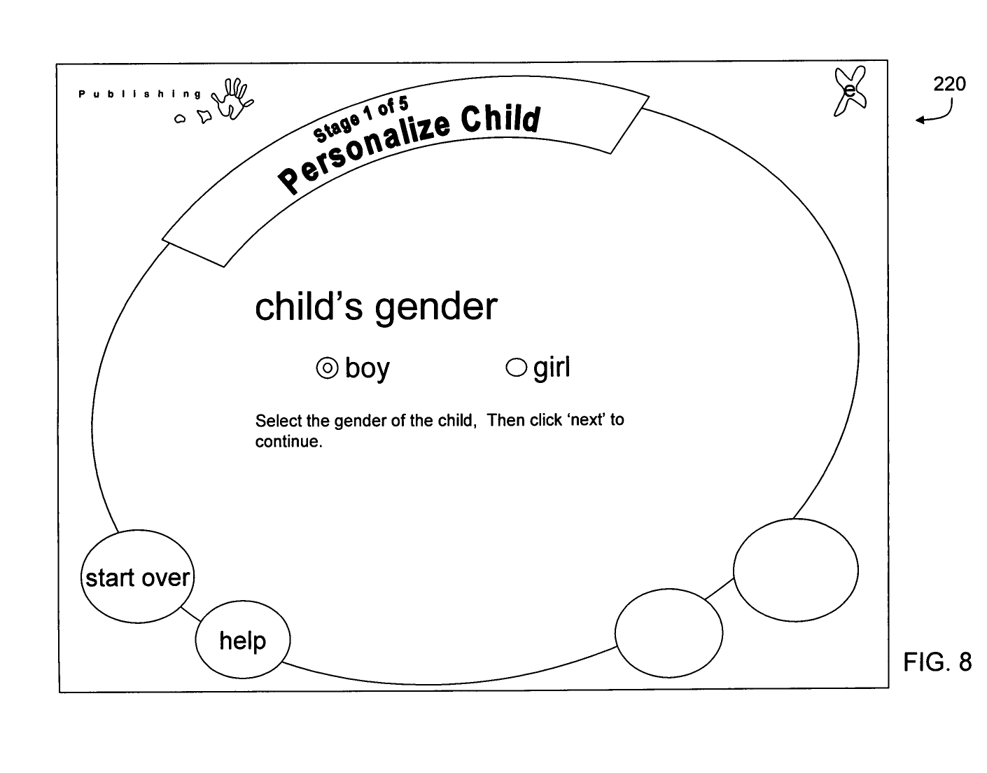

FIG. 8 is a gender entry screen 220 through which a user of kit 100 may select the gender of the child for whom the personalized book is being prepared. After gender selection, the user may select a next button to proceed to the next data entry screen or a back button to go back to the name entry screen 210.

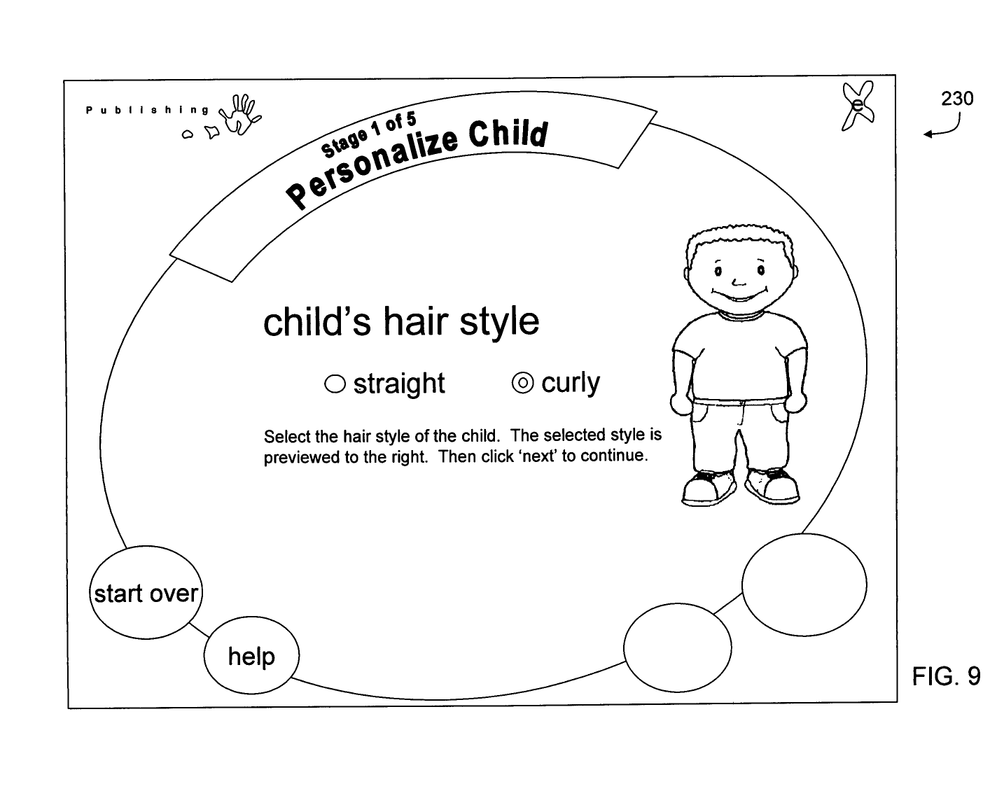

FIG. 9 is a hair style entry screen 230 through which a user of kit 100 may enter the hair style, for example, straight or curly, of the child for whom the personalized book is being prepared. An image of a child of the previously selected gender is shown on the right of the screen with the selected hair style. After hair style entry, the user may select a next button to proceed to the next data entry screen or a back button to go back to the gender entry screen 220.

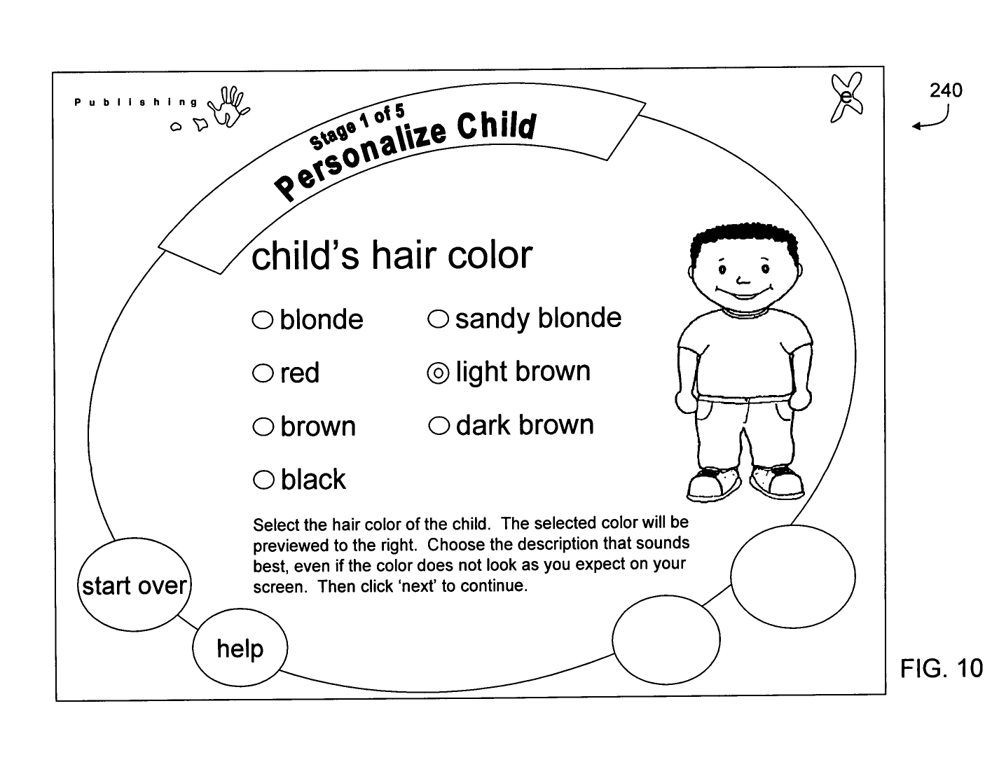

FIG. 10 is a hair color entry screen 240 through which a user of kit 100 may select an approximate hair color of the child for whom the personalized book is being prepared. An image of a child with the selected gender and hair style is shown with the chosen hair color. After hair color entry, the user may select a next button to proceed to the next data entry screen or a back button to go back to the hair style entry screen 230.

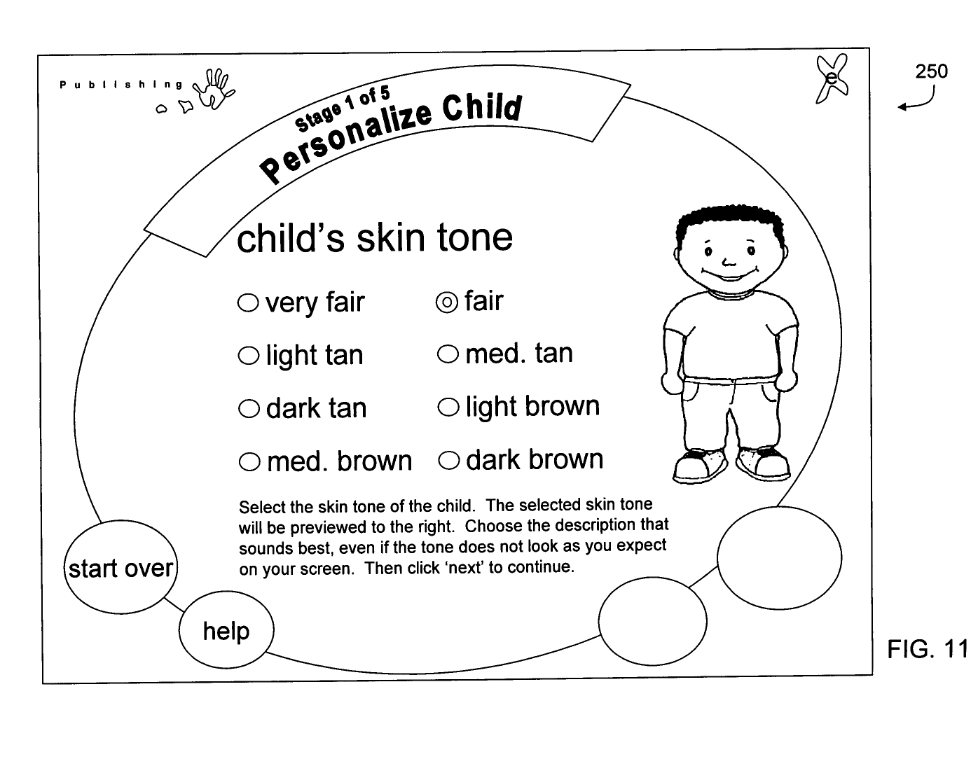

FIG. 11 is a skin tone entry screen 250 through which a user of kit 100 may enter an approximate skin tone of the child for whom the personalized book is being prepared. An image of a child with the selected gender, hair style, and hair color is shown with the chosen skin tone. After skin tone entry, the user may select a next button to proceed to the next data entry screen or a back button to go back to the hair color entry screen 240.

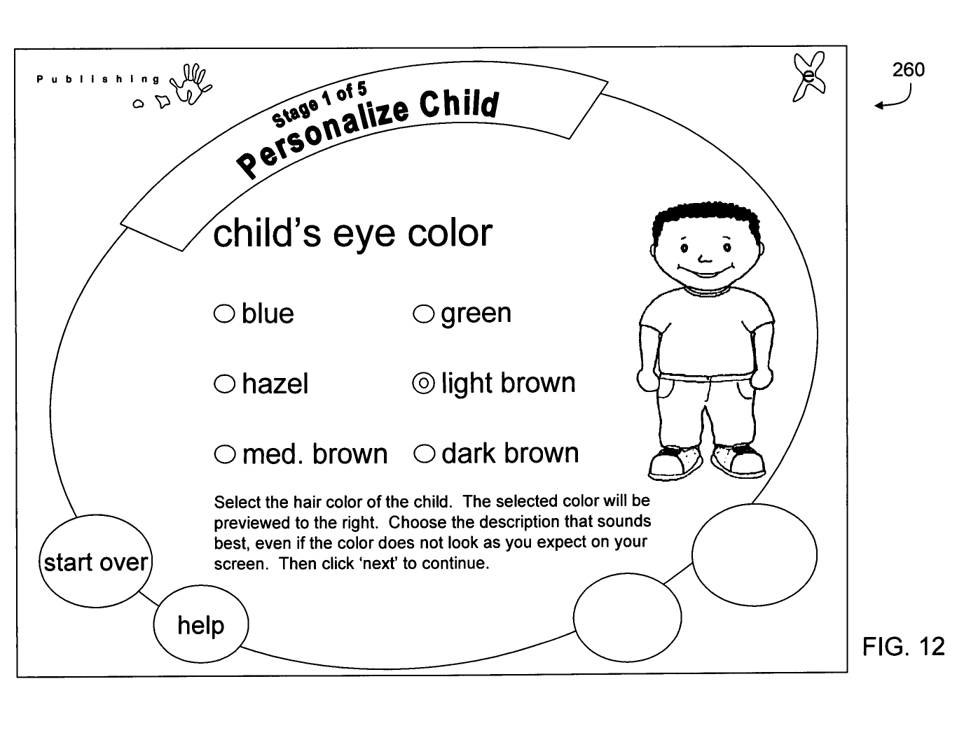

FIG. 12 is an eye color entry screen 260 through which a user of kit 100 may enter an approximate eye color of the child for whom the personalized book is being prepared. An image of a child with the selected gender, hair style, hair color, and skin tone is shown with the chosen eye color. After eye color entry, the user may select a next button to proceed to the next data entry screen or a back button to go back to the skin tone entry screen 250.

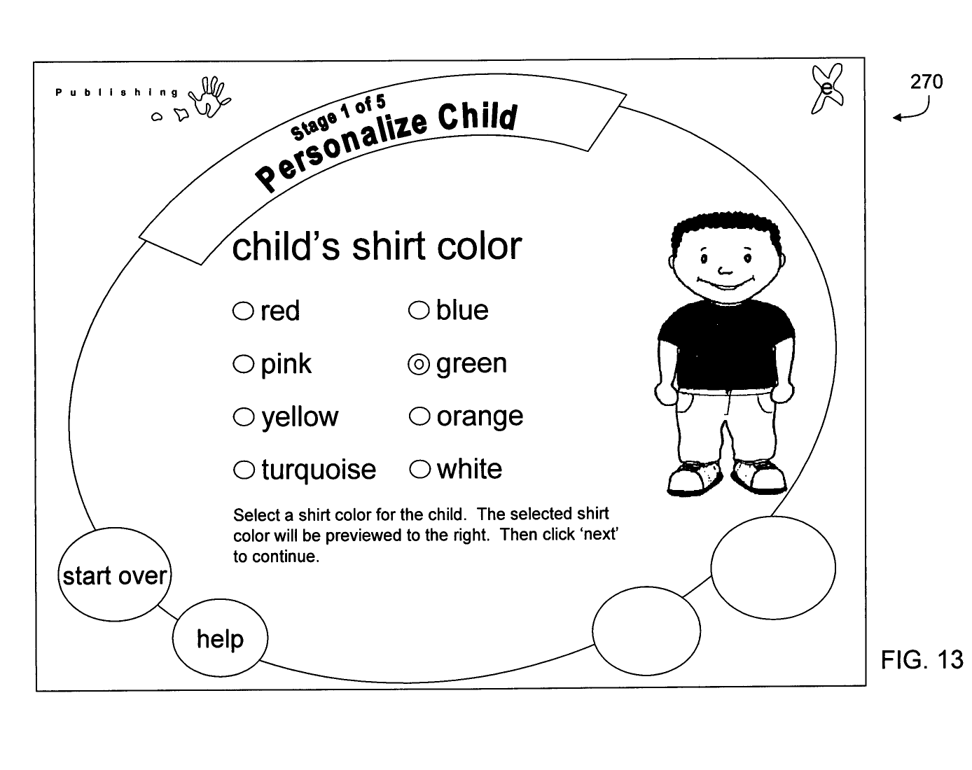

FIG. 13 is a shirt color entry screen 270 through which a user of kit 100 may enter an approximate shirt color of the child for whom the personalized book is being prepared. An image of a child with the selected gender, hair style, hair color, skin tone and eye color is shown with the chosen shirt color. After shirt color entry, the user may select a next button to proceed to the next data entry screen or a back button to go back to the eye color entry screen 260.

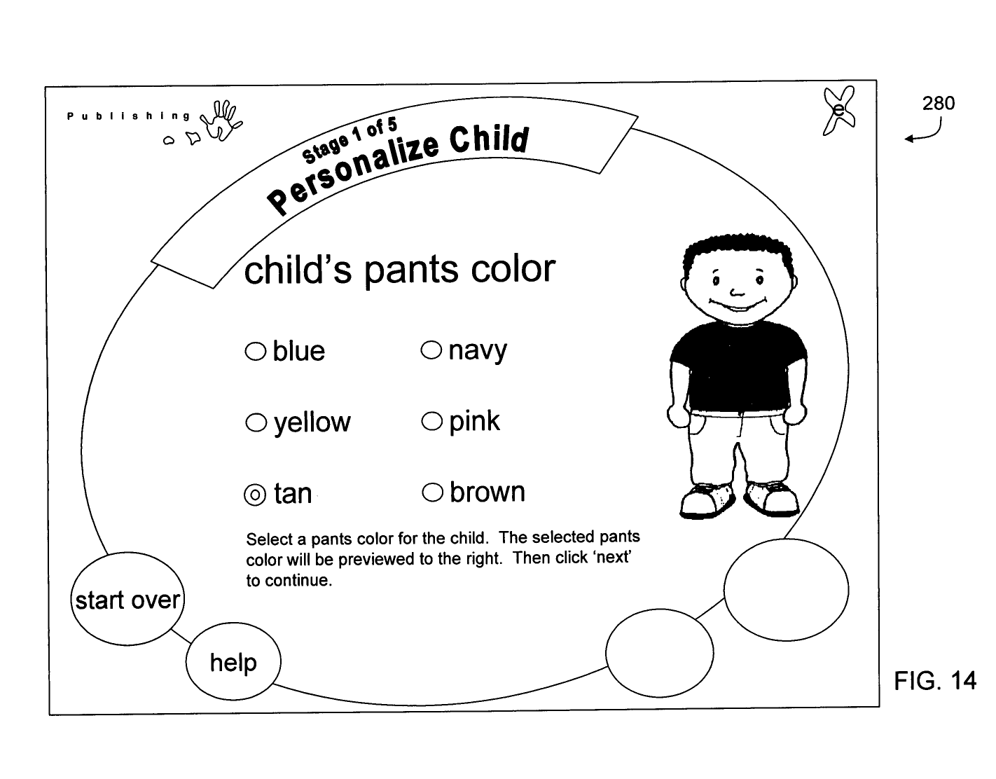

FIG. 14 is a pants color entry screen 280 through which a user of kit 100 may enter an approximate pants color of the child for whom the personalized book is being prepared. An image of a child with the selected gender, hair style, hair color, skin tone, eye color and shirt color is shown with the chosen pants color. After pants color entry, the user may select a next button to proceed to the next data entry screen or a back button to go back to the shirt color entry screen 270.

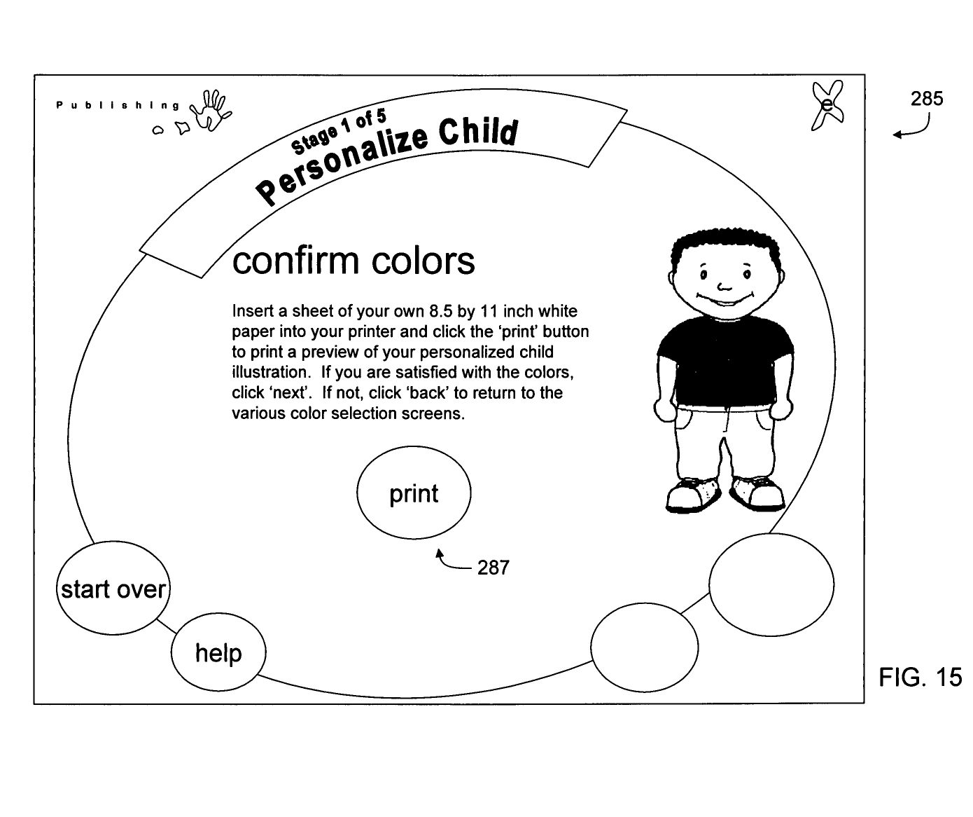

FIG. 15 is an example color confirmation screen 285 which allows a user to select to print a preview copy of the personalized child illustration that includes all of the features entered and selected as described with respect to FIGS. 8-14. To print the preview copy, a print button 287 is selected by the user. The user may select a next button to proceed to the next data entry screen or a back button to go back to the pants color entry screen 280.

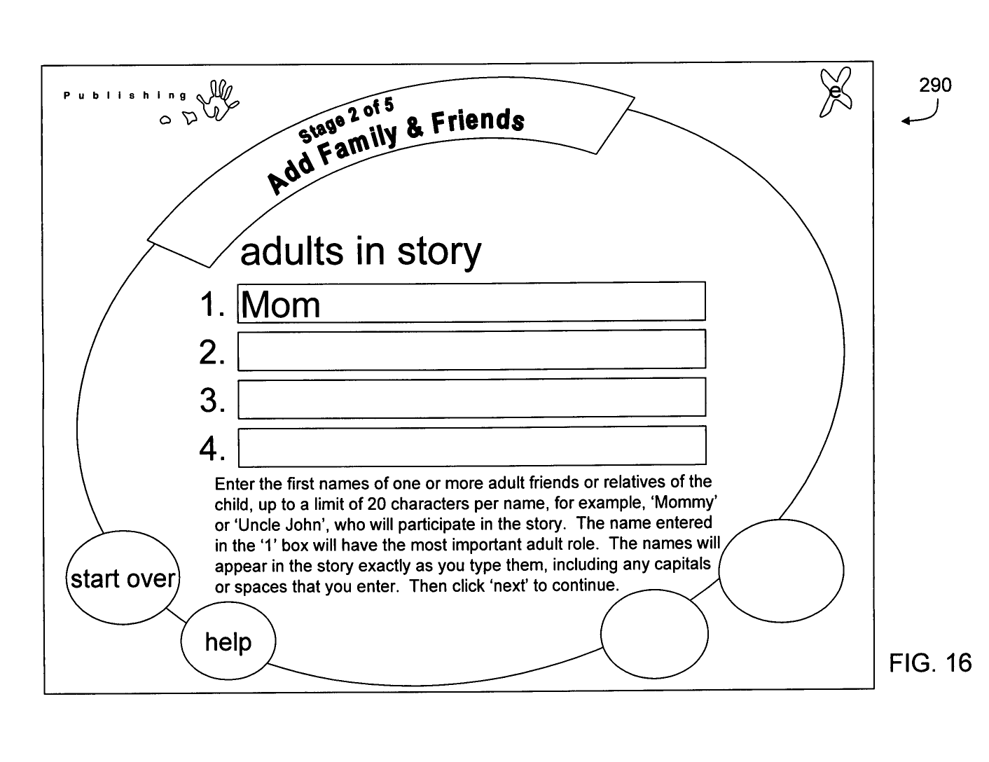

FIG. 16 is an adults in story entry screen 290 through which a user of kit 100 may enter the first names of one or more adults that will be included in the text of the personalized book being prepared for the child. After entry of the first names of one or more adults, for example, the first adult name entry having a prominent role in the personalized story, the user may select a next button to proceed to the next data entry screen or a back button to go back to the color confirmation screen 285.

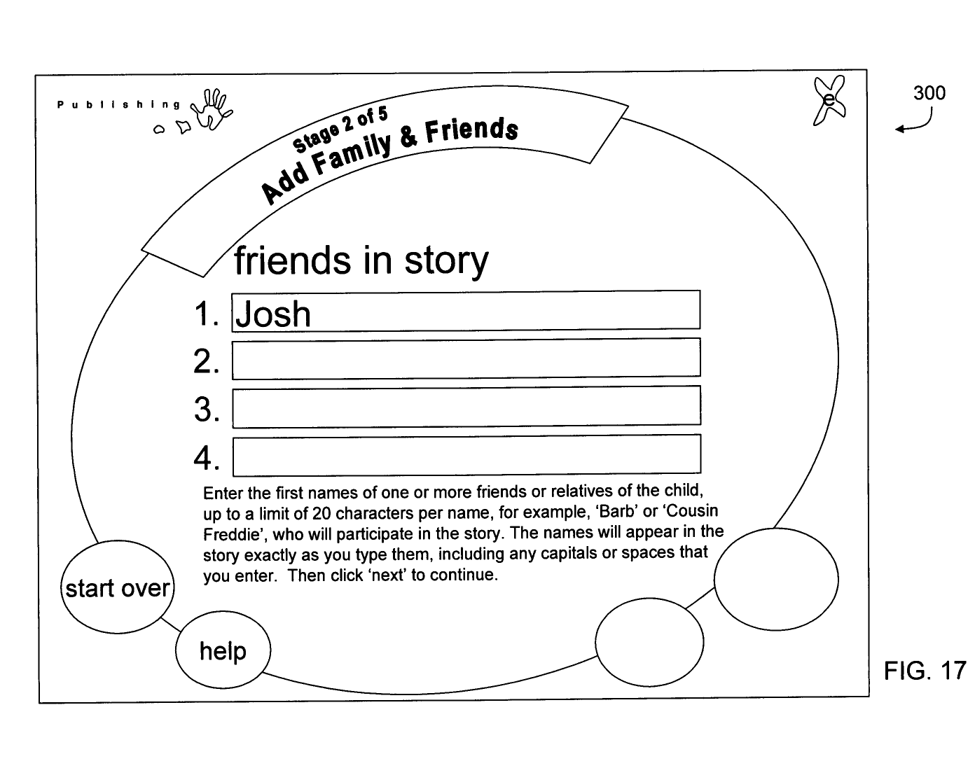

FIG. 17 is a friends in story entry screen 300 through which a user of kit 100 may enter the first names of one or more friends that will be included in the text of the personalized book being prepared for the child. After entry of the first names of one or more friends, the user may select a next button to proceed to preview and edit book pages screen or a back button to go back to the adults in story entry screen 290.

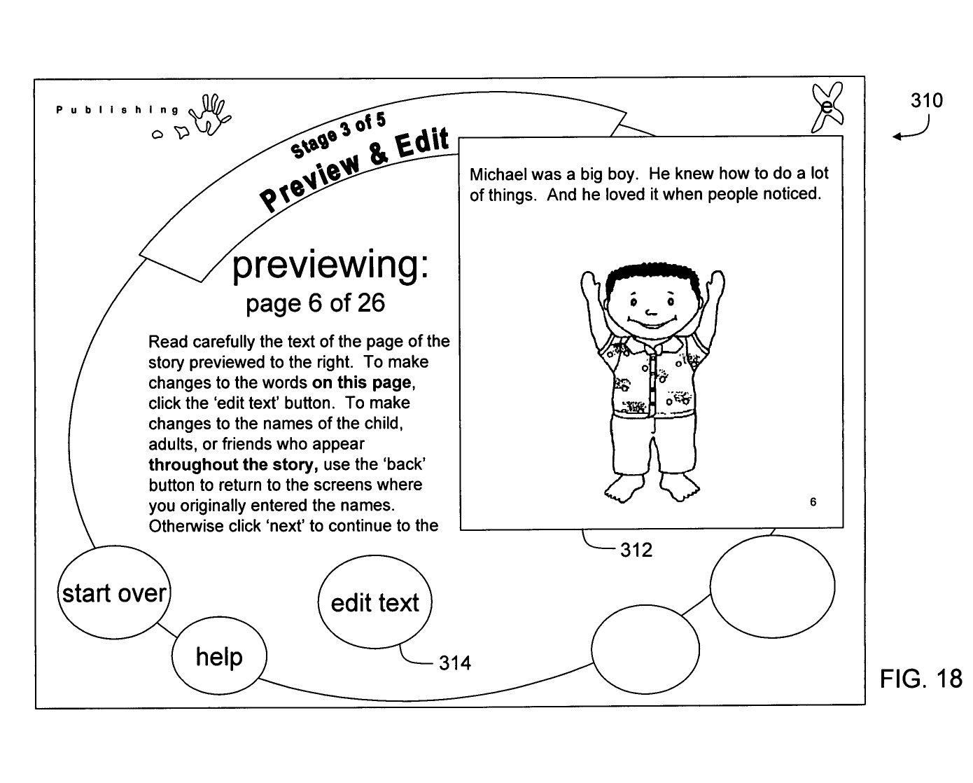

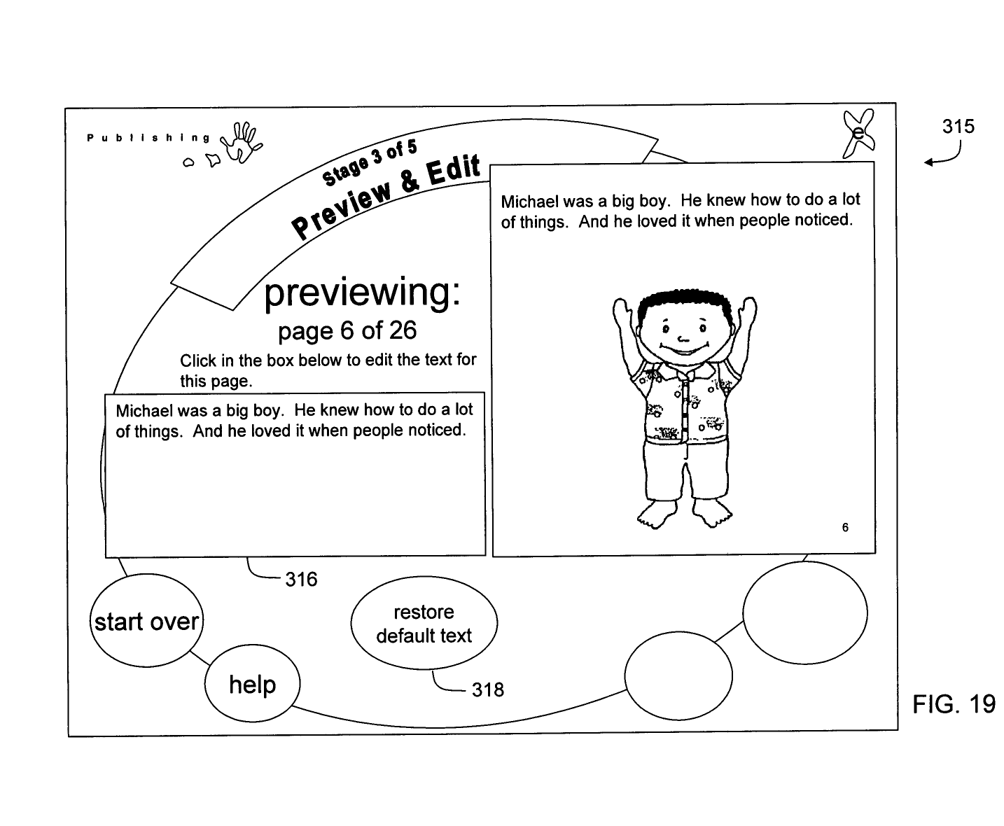

FIG. 18 is a preview and edit book pages screen 310 through which a user of kit 100 may review the above described graphical and textual entries. For example, screen 310 includes a window 312 where the user can look at each page of the personalized book at it will eventually be printed. An edit text button 314 allows the user to edit the text of the page being displayed in window 312 as further described with respect to FIG. 19. The user may select a next button to proceed to a configure printer screen or a back button to go back to the friends in story entry screen 300.

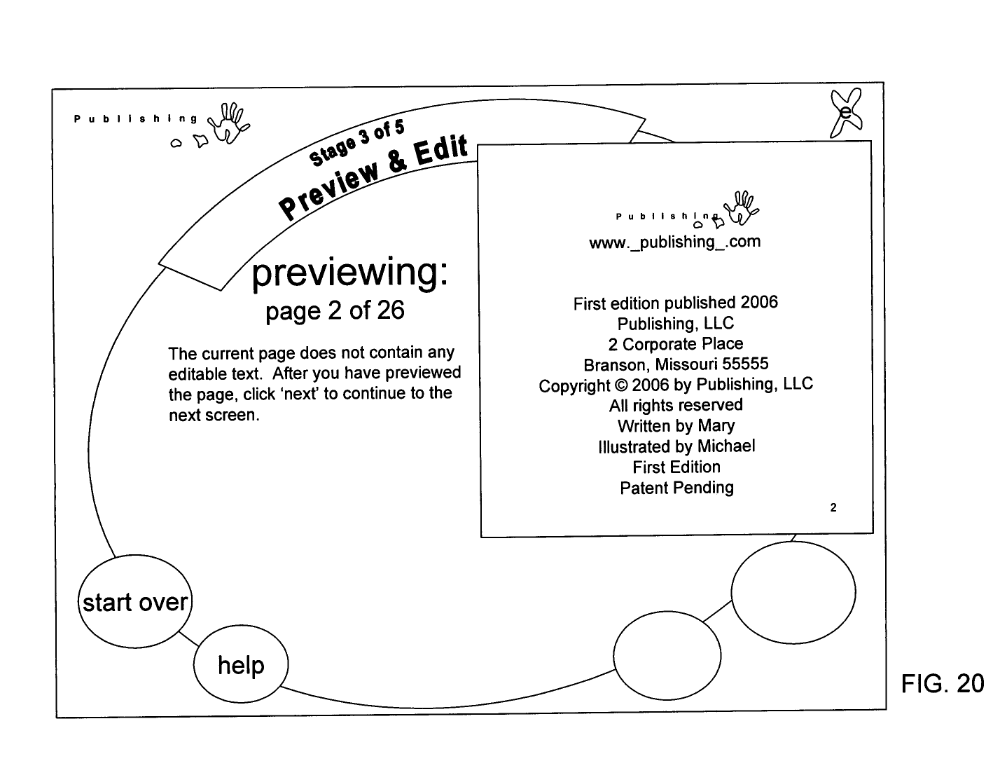

FIG. 19 is an example edit book pages screen 315. A text box 316 is provided in which is displayed the current text for the displayed page. The user may edit the text that is displayed in text box 316, or restore the default text through selection of a restore default text button 318. FIG. 20 is an example of a book page that does not include any editable text.

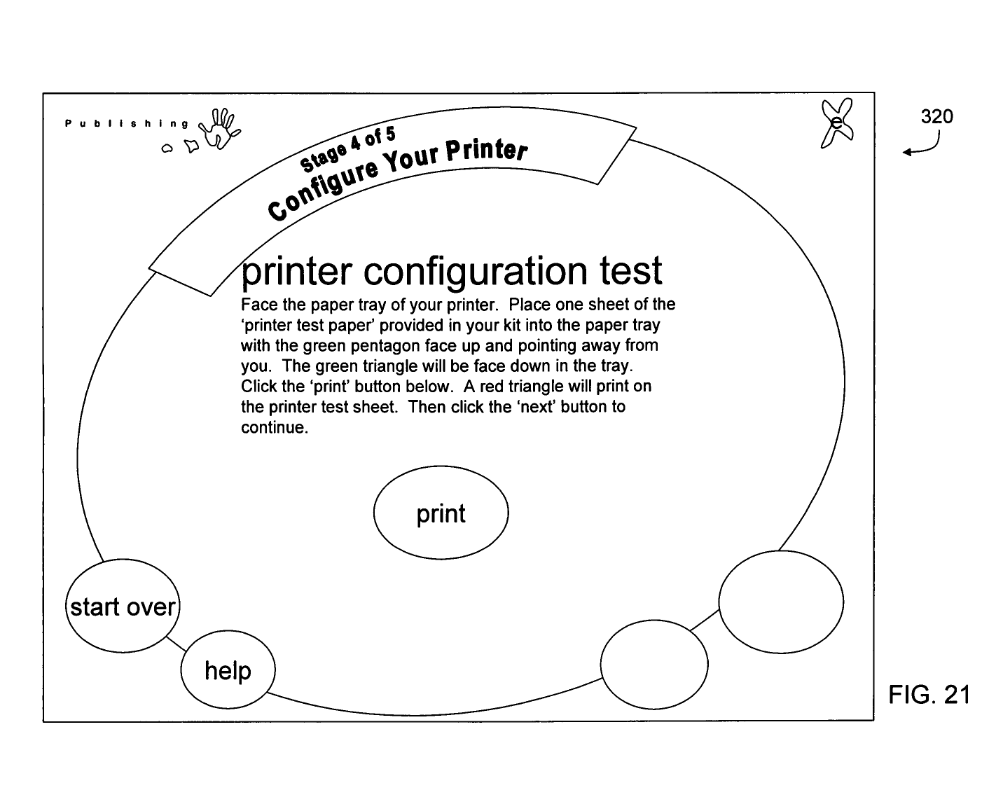

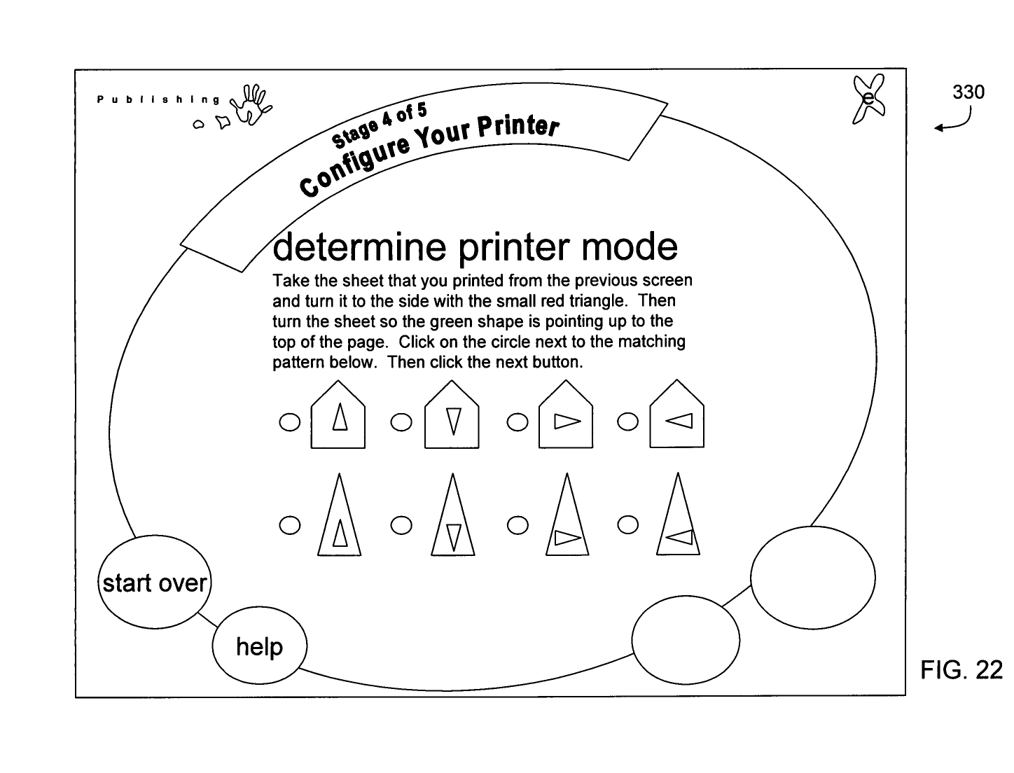

FIG. 21 is a print configuration test screen 320. In one embodiment, screen 320 instructs the user to insert one sheet of test paper into their printer to print a test pattern. The test pattern is then utilized along with a series of patterns displayed within determine printer mode screen 330, shown in FIG. 22 to correctly orient the sheets of paper to be bound into the book for a particular printer. The technical effect of screens 320 and 330 and the question associated therewith is to ensure that the pre-punched sheets for the book are printed correctly for future binding within the covers as described above. After completion of the printer mode screen the user may select a next button to proceed to a ready to print book pages screen or a back button to go back to the determine printer mode screen 330.

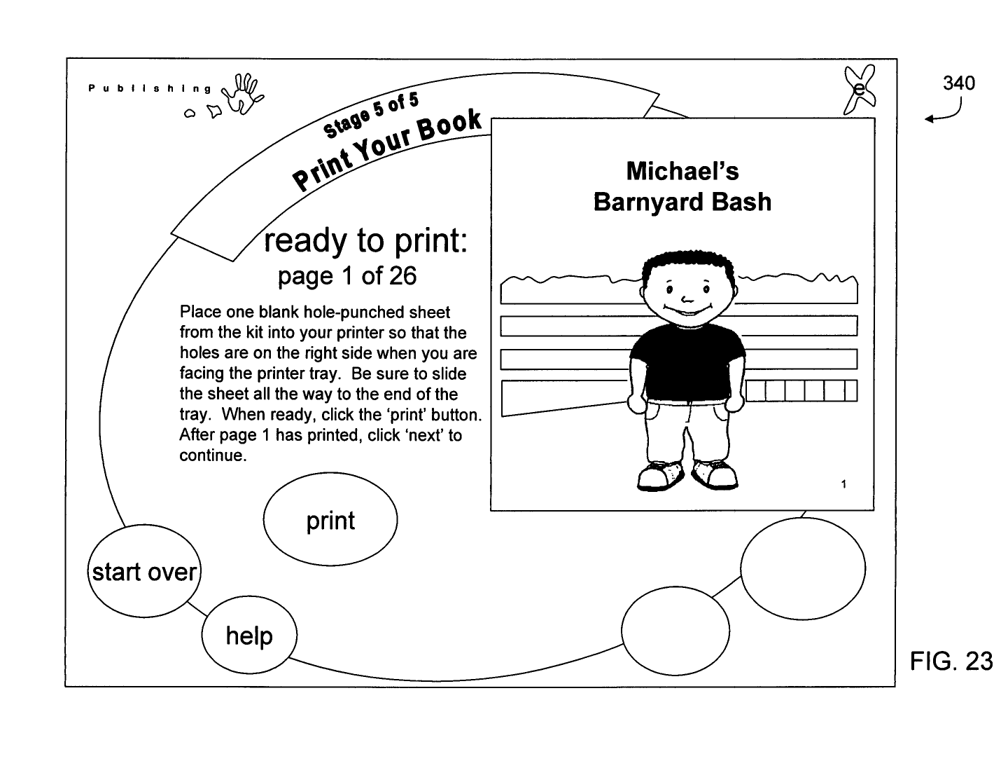

FIG. 23 is an example ready to print book pages screen 340. In one embodiment, screen 340 instructs the user to insert one sheet of paper to be used for a page of the personalized book into their printer. The instructions provided within screen 340 instruct the user as to the orientation of the sheet of paper so that the pages are correctly printed to accommodate future binding of the book. The computer program aligns the personalized characters and text and sets a left margin for the pages. As such, a preview 342 of the page to be printed is included within screen 340. Selection of a print button 344 causes a page of the book to be printed.

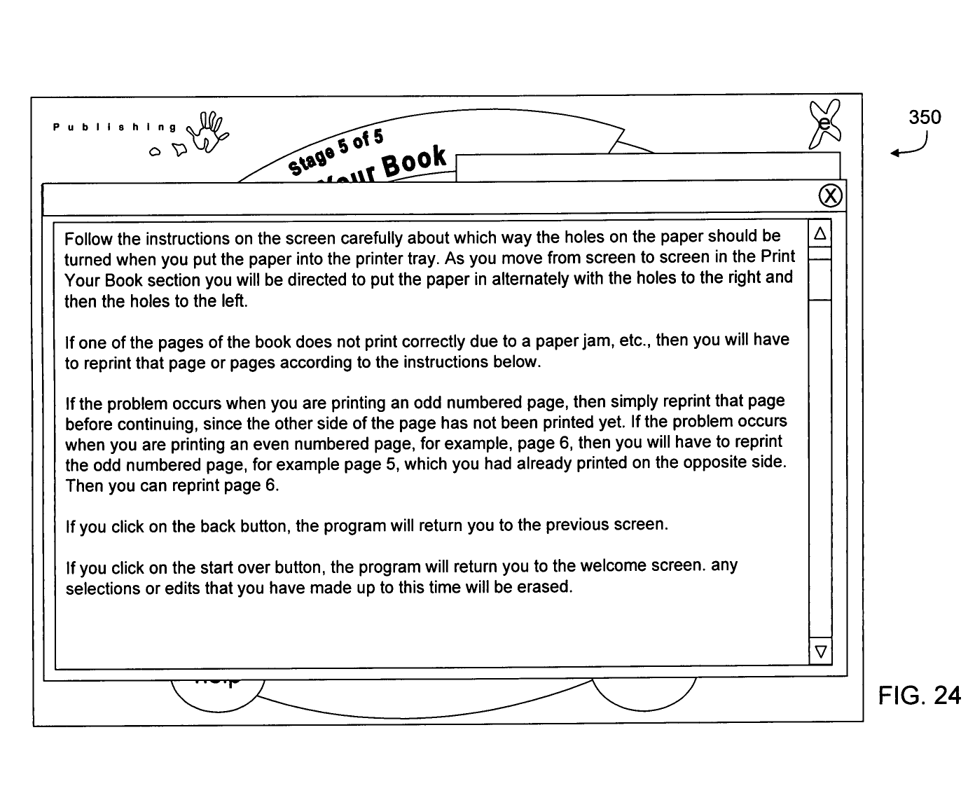

FIG. 24 is an example help screen 350 that may be accessed from screen 340.

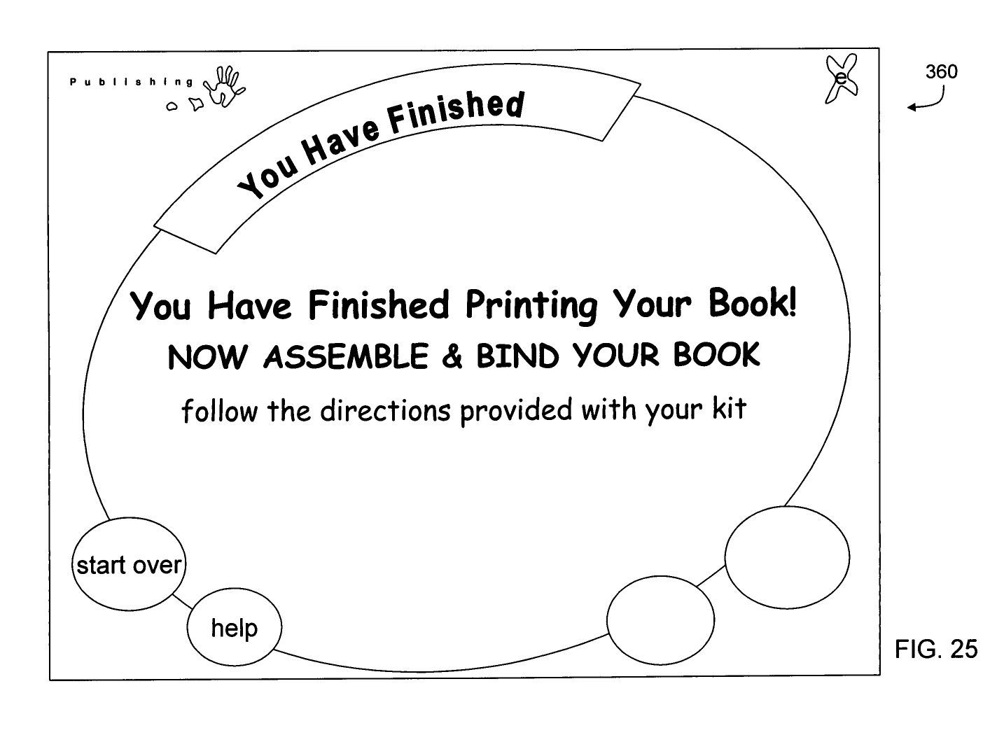

FIG. 25 is an example book finished screen 360 that is displayed after the printing of the pages of the personalized book is completed.

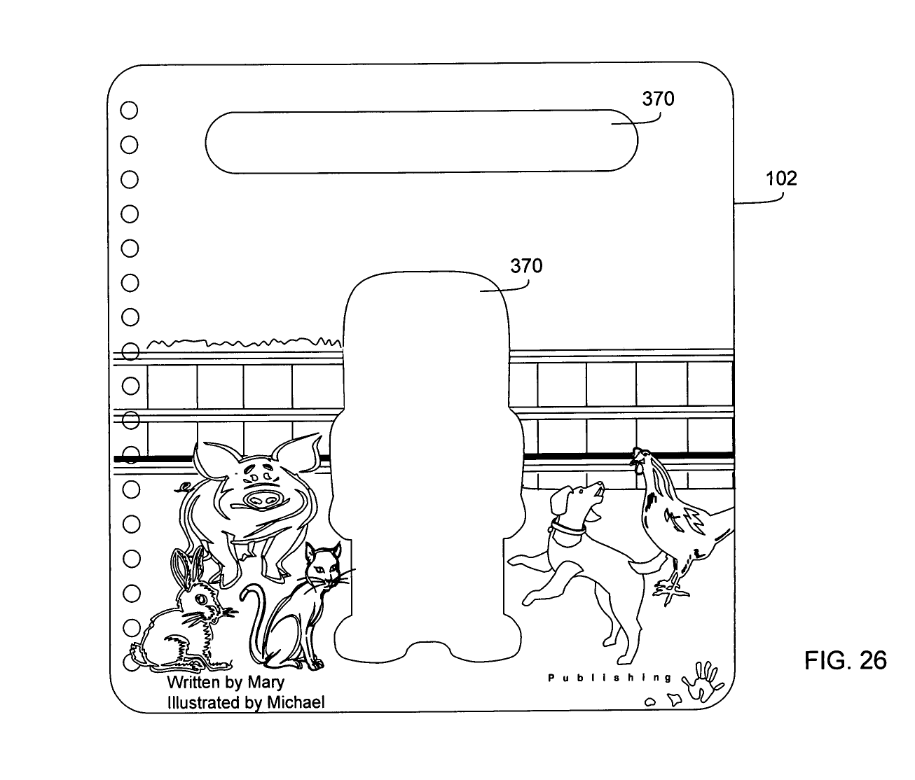

FIG. 26 is an illustration of front cover 102 for a personalized book which is configured to be bound with personalized pages that have been produced as above described. As illustrated, cover 102 is configured with one or more openings 370 therethrough such that, for example, one or more of a picture of the personalized graphics for a child and personalized text associated with the child may be aligned therewith. Such personalized graphics and text, in one embodiment are printed on the first page of the book.

The apparatus and processes described herein provide a personalized book that includes both a cover through which personalized text and graphics may be viewed and personalized inside pages that include both text and graphics, which is believed to be an improvement over prior art personalized books which either do not include covers personalized as to text and graphics, pages personalized with both text and graphics, or those that incorporate stickers for personalization of some or all of the covers and pages. The methods described herein result in a book which includes a personalized hard cover and personalized dedication and inside pages, all of which are printed on the same media using a single printer type.

Such a book is also very simple to print and easy and quick to assemble and bind with readily available tools, in contrast to known personalized books which often utilize expensive offset printers for preprinting of generic portions of the book and require complicated collation and binding processes. Therefore preparation of the personalized book described herein is economical and uses an easily obtainable laser or inkjet type of printer. In this method there is no need for preprinting of the preponderance of the generic text and graphics usually done with a traditional offset printing process.

In other known personalization methods, alternating graphics pages and text pages are utilized, some of which are preprinted, which increases a probability of operator error as the preprinted pages are fed into a printer for customization. As such, a system configuration for the easy customization, printing, and binding of personalized books is also disclosed in which preprinted pages cannot be ruined through operator printing errors as all pages begin the single printing process described herein as blank sheets.

While the invention has been described in terms of various specific embodiments, those skilled in the art will recognize that the invention can be practiced with modification within the spirit and scope of the claims.

What is claimed is:

1. A method for preparing and printing a personalized book utilizing a software package installed on a personal computer, said method comprising:
entering, via one or more graphical user interfaces displayed on the computer, personalization features for at least one character in the book;
editing, via one or more additional graphical user interfaces displayed on the computer, at least one of character names and text of a story included in the software package;
running a printer test to determine an orientation for blank pages on which the personalized book will be printed with respect to a printer connected to the personal computer;
printing the pages of the book in a single pass of the blank pages through the printer, the single printing pass including the printing of the personalized text, personalized characters, and background illustrations; and
binding the printed pages of the book.

2. A method in accordance with claim 1 wherein entering personalization features for at least one character comprises entering at least one of gender, hair style, hair color, skin tone, eye color, shirt color, and pants color for one or more characters in the book.

3. A method in accordance with claim 1 further comprising running the software package to align the personalized characters and the personalized text for printing on the pages.

4. A method in accordance with claim 1 further comprising running the software package to set a left margin of the pages.

5. A method in accordance with claim 1 wherein running a printer test to determine an orientation for blank pages further comprises printing a symbol on a test page that includes at least one pre-printed symbol, an orientation of the symbol with respect to the pre-printed symbol illustrative of how the blank pages are to be oriented in the printer.

6. A method in accordance with claim 5 wherein running a printer test to determine an orientation for blank pages further comprises:
selecting from a plurality of symbol and pre-printed symbol orientations using one or more additional graphical user interfaces displayed on the computer; and
displaying, via one or more additional graphical user interfaces displayed on the computer, directions for inserting the blank pages into the printer.

7. A method in accordance with claim 1 wherein editing, via one or more additional graphical user interfaces displayed on the computer, at least one of character names and text of a story further comprises editing the name of at least one character and the text of the story via separate graphical user interfaces displayed on the computer.

8. A method in accordance with claim 1 further comprising restoring a default story text from the software packing using one or more additional graphical user interfaces displayed on the computer.

9. A method in accordance with claim 1 further comprising providing the capability to:
review each page via one or more additional graphical user interfaces displayed on the computer; and
edit at least one of the pages reviewed via the graphical user interfaces.

10. A computer-readable medium for use in a personal computer, said computer readable medium having recorded thereon machine readable instructions configured to cause the personal computer to:
display one or more graphical user interfaces that allow a user to personalize features for at least one character in a book;
display one or more additional graphical user interfaces that allow a user to edit at least one of character names and a text of a story included on the computer readable medium;
instruct a printer connected to the personal computer to run a printer test to determine an orientation for blank pages on which the personalized book will be printed with respect to the printer; and
instruct the printer to print the pages of the book in a single pass of the blank pages through the printer, the single printing pass including the printing of the personalized text, the personalized characters, and background illustrations.

11. A computer-readable medium in accordance with claim 10 further comprising machine readable instructions configured to cause the computer to display one or more graphical user interfaces that allow a user to enter at least one of gender, hair style, hair color, skin tone, eye color, shirt color, and pants color for one or more characters in the book.

12. A computer-readable medium in accordance with claim 10 further comprising machine readable instructions configured to cause the computer to align the personalized characters and the personalized text to be printed on the pages.

13. A computer-readable medium in accordance with claim 10 further comprising machine readable instructions configured to cause the computer to set a left margin of the pages.

14. A computer-readable medium in accordance with claim 10 further comprising machine readable instructions configured to cause the computer to:
instruct the printer to print a symbol on a test page that includes at least one pre-printed symbol, an orientation of the symbol with respect to the pre-printed symbol illustrative of how the blank pages are to be oriented in the printer.
display, on one or more additional graphical user interfaces, a plurality of symbol and pre-printed symbol orientations; and
display, on one or more additional graphical user interfaces, an orientation for the blank pages for insertion into the printer based on a user selection of one of the symbol and pre-printed symbol orientations.

15. A computer-readable medium in accordance with claim 10 further comprising machine readable instructions configured to cause the computer to display one or more graphical user interfaces that allow a user to restore of a default story text.

16. A computer-readable medium in accordance with claim 10 further comprising machine readable instructions configured to cause the personal computer to display one or more graphical user interfaces that allow a user to review and edit at least one of each individual page of the book.

17. A computer-readable medium in accordance with claim 10 further comprising machine readable instructions configured to cause the computer to:
display one or more additional graphical user interfaces that allow a user to edit the name of at least one character in the book; and
display one or more separate graphical user interfaces that allow a user to edit the text of the story.

18. A kit for personalizing a book, said kit comprising:
software configured to be installed on a personal computer and configured to allow a user to personalize the book by editing at least one of character names and a text of a story included in the software, personalize characteristics for one or more characters in the book, and print pages of the book;
a front cover;
a back cover;
a plurality of blank pages configured to have the personalized text, the personalized characters, and background illustrations printed thereon in a single pass of the blank pages through a printer;
a printer test page configured to allow a user to properly align said blank pages in a printer connected to the personal computer; and
a binding material configured to bind said plurality of pages between said front cover and said back cover.

19. A kit in accordance with claim 18 wherein said front cover comprises at least one cutout formed therein and configured to align with an illustration on a first page.

20. A kit in accordance with claim 18 further comprising directions to instruct a user how to bind the personalized book.
